(19) United States
(12) Patent Application Publication
(10) Pub. No.: US 2016/0180758 A1
(43) Pub. Date: Jun. 23, 2016

(54) DISPLAY APPARATUS INCORPORATING A CHANNEL BIT-DEPTH SWAPPING DISPLAY PROCESS

(71) Applicant: Pixtronix, Inc., San Diego, CA (US)

(72) Inventor: Edward Buckley, Melrose, MA (US)

(21) Appl. No.: 14/581,579

(22) Filed: Dec. 23, 2014

(51) Int. Cl. G09G 3/20

(52) U.S. Cl. CPC G09G 3/2003; G09G 2320/0666

(57) ABSTRACT

This disclosure provides systems, methods, and apparatus for generating images on a multi-primary display. A multi-primary display can include control logic that provides sets of subframe slots for displaying color subfields of an image frame. Each set includes a fixed number of subframe slots, which can be used for displaying any or all image subframes output by the display. The control logic can evaluate the image frame to determine which one of the sets of subframe slots to assign to each of the color subfields used to display the image frame. For example, the control logic can display the image frame using red (R), green (G), blue (B) and white (W) color subfields. The control logic determines which set of subframe slots to assign each subfield based on relative luminances of the color subfields within the image frame.

### TECHNICAL FIELD

This disclosure relates to the field of imaging displays, and in particular to image formation processes for multi-primary displays.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers.

Electromechanical elements may be created using deposition, etching, lithography, and/or other micromachining processes that etch away parts of substrates and/or deposited material layers, or that add layers to form electrical and electromechanical devices.

EMS-based display apparatus can include display elements that modulate light by selectively moving a light blocking component into and out of an optical path through an aperture defined through a light blocking layer. Doing so selectively passes light from a backlight or reflects light from the ambient or a front light to form an image.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus including an array of display elements and control logic configured to receive an image frame, provide a plurality of sets of subframe slots, each set including a fixed number of subframe slots, determine relative luminances of a plurality of color subfields associated with the image frame, assign, based on the determined relative luminances, each of the plurality of color subfields to one of the plurality of sets of subframe slots, and display, using the array of display elements, each of the plurality of color subfields using a number of subframes equal to the number of subframe slots included in the set of subframe slots assigned to the color subfield.

In some implementations, the control logic is configured to provide a preliminary output sequence including a set of color subfield-independent timing event parameters associated with each of the subframe slots. In some implementations, the timing event parameters include at least one of a data load time, an illumination duration, an illumination start time, an illumination end time, and a display element actuation time.

In some implementations, the control logic is configured to generate a final output sequence by updating the preliminary output sequence with color subfield-specific parameters based on the assignment of the color subfields to the sets of subframe slots. In some implementations, the color subfield-specific parameters include memory addresses of subframes associated with the respective color subfields. In some implementations, the color subfield-specific parameters include at least one light source intensity value associated with each color subfield.

In some implementations, the control logic is configured to assign the color subfields to the sets of subframe slots such that the color subfields are assigned sets of subframe slots having decreasing numbers of subframe slots in order of decreasing relative luminances of the plurality of color subfields. In some implementations, determining relative luminances of each of the plurality of color subfields within the received input image frame includes determining the relative luminances of the plurality of color subfields in a color space transform derived from the received image frame. In some implementations, the color space transform is a function of a saturation metric determined by the control logic for the image frame. In some implementations, the control logic is further configured to dither each of the color subfields based on the number of subframe slots included in the set of subframe slots assigned to the color subfield.

In some implementations, the apparatus further includes a display, a processor capable of communicating with the display, the processor being capable of processing image data, and a memory device capable of communicating with the processor. In some implementations, the apparatus further includes a driver circuit capable of sending at least one signal to the display, and a controller capable of sending at least a portion of the image data to the driver circuit. In some implementations, the apparatus further includes an image source module capable of sending the image data to the processor, where the image source module includes at least one of a receiver, transceiver, and transmitter. In some implementations, the apparatus further includes an input device capable of receiving input data and communicating the input data to the processor.

Another innovative aspect of the subject matter described in this disclosure can be implemented in a method for displaying an image on a display. The method includes receiving an image frame, providing a plurality of sets of subframe slots, each set including a fixed number of subframe slots, determining relative luminances of each of a plurality of color subfields associated with the image frame, assigning, based on the relative luminances, each of the plurality of color subfields to one of the plurality of sets of subframe slots, and displaying, using an array of display elements, each of the plurality of subfields using a number of subframes equal to the number of subframe slots included in the set of subframe slots assigned to the color subfield.

In some implementations, the method further includes providing a preliminary output sequence including a set of color subfield-independent timing event parameters associated with the subframe slots. In some implementations, the timing event parameters include at least one of a data load time, an illumination duration, an illumination start time, an illumination end time, and a display element actuation time.

In some implementations, the method further includes generating a final output sequence by updating the preliminary output sequence with color subfield-specific parameters based on the assignment of the color subfields to the sets of subframe slots. In some implementations, the color subfield-specific parameters include memory addresses of subframes associated with the respective color subfields. In some implementations, the color subfield-specific parameters include at least one light source intensity value associated with each color subfield.

In some implementations, assigning each of the plurality of color subfields to one of the plurality of sets of subframe slots based on the relative luminances includes assigning the color subfields to sets of subframe slots having decreasing numbers of subframe slots in the order of decreasing relative luminances of the plurality of color subfields. In some implementations, determining relative luminances of each of a plurality of color subfields associated with the image frame includes determining the relative luminances of the plurality of color subfields in a color space transform derived from the received image frame. In some implementations, the color space transform is a function of saturation metric determined for the image frame. In some implementations, the method further includes dithering each of the plurality of color subfields based on the number of subframes slots included in the set of subframe slots assigned to the color subfield.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIG. 3 shows a block diagram of an example display apparatus.

FIG. 4 shows a block diagram of example control logic suitable for use as, for example, the control logic in the display apparatus shown in FIG. 3.

FIG. 5 shows a flow diagram of an example process for generating an image on a display using the control logic shown in FIG. 4.

FIG. 6 shows an example preliminary output sequence to be utilized by the control logic shown in FIG. 4.

FIG. 7 shows a flow diagram of an example process for image transformation utilizing a saturation metric.

FIG. 8 shows a flow diagram of another example process for generating an image on a display.

FIGS. 9A and 9B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

A multi-primary display can include control logic that converts input image data into a multi-primary color space. In some implementations, the multi-primary display can output the image data using time division gray scale using a reduced number of subframes for each color subfield in the multi-primary color space. Reducing the number of subframes used to output the image data can reduce the power expended in doing so. However, adjusting the computational power involved in modifying the number of subframes and the associated timing parameters used to output image data on a frame-by-frame basis to take advantage of this potential power savings can mitigate or in some cases even obviate the power gains. To preserve power gains while maintaining image quality, the control logic provides sets of subframe slots for displaying the subfields of an image. Each set includes a fixed number of subframe slots, which can be used for displaying any or all image frames output by the display. Upon receiving an image frame, the control logic can evaluate the image frame to determine one of the sets of subframe slots to assign to each of the color subfields used to display the image. For example, the control logic can display the image frame using red (R), green (G), blue (B) and white (W) color subfields. The control logic determines which set of subframe slots to assign each subfield based on relative luminances of the color subfields within the image frame.

The control logic can maintain a preliminary output sequence including the sets of subframe slots. The preliminary output sequence includes color independent timing parameters associated with each of the subframe slots. For example, the preliminary output sequence can include coded weights, data loading times, actuation times, and lamp illumination times for each subframe slot. After the control logic assigns color subfields to the sets of subframe slots, the control logic updates the output sequence with color-dependent parameters, such as light source intensities and memory locations for display element states for each of the subframe slots to generate a final output sequence. The control logic then displays the subframes for each of the color subfields using the final output sequence.

Particular implementations of the subject matter described in this disclosure can be implemented to realize one or more of the following potential advantages. By providing one or more preliminary output sequences that each includes multiple sets of subframe slots, and with the sets including different numbers of subframe slots, the computational complexity of changing the number of subframes used to output each subfield of an image frame on a frame-by-frame basis can be greatly reduced. This reduction in computational complexity can result in reduced power consumption while maintaining or even improving image quality. In some implementations, the control logic of a display apparatus can maintain different sets of subframe slots in association with different operating modes to allow further adjustment to the manner in which an image frame is output, again without unduly increasing the computation complexity of doing so. Thus, the display apparatus maintaining such sets of subframe slots can provide reduced power, high quality image display in a wider variety of contexts and settings.

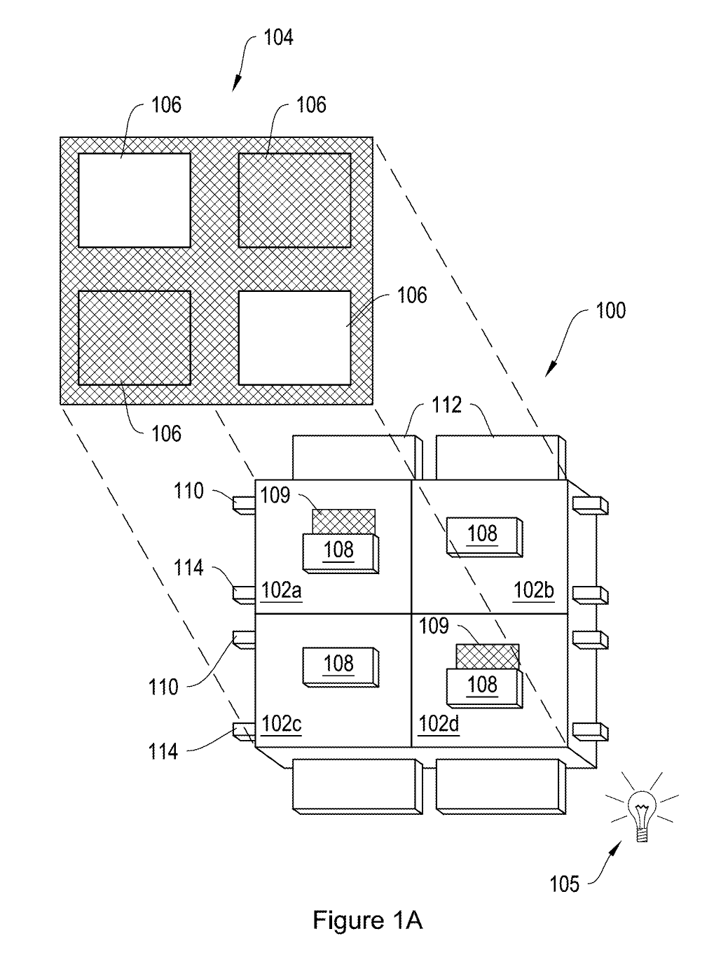

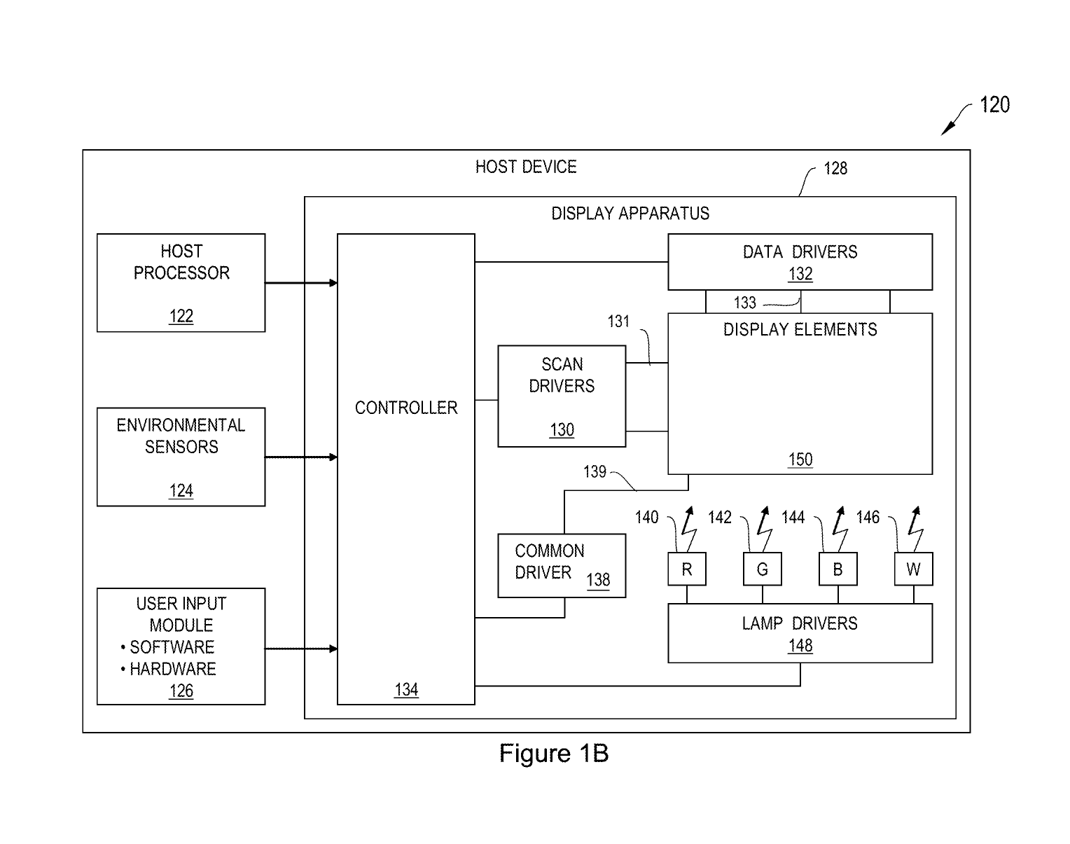

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

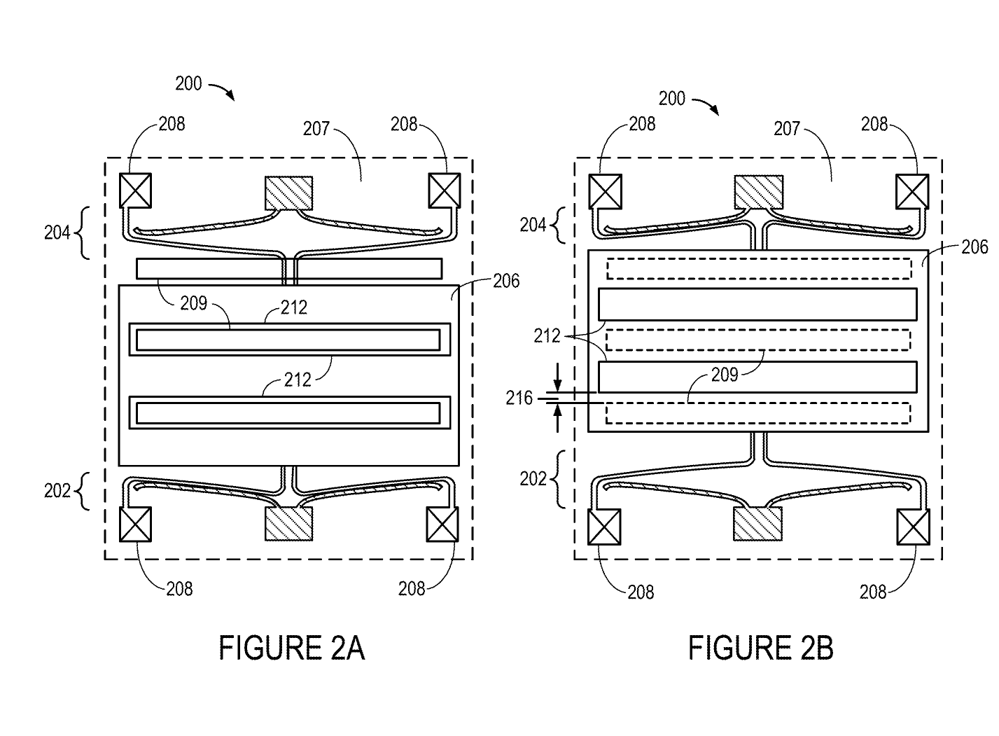

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

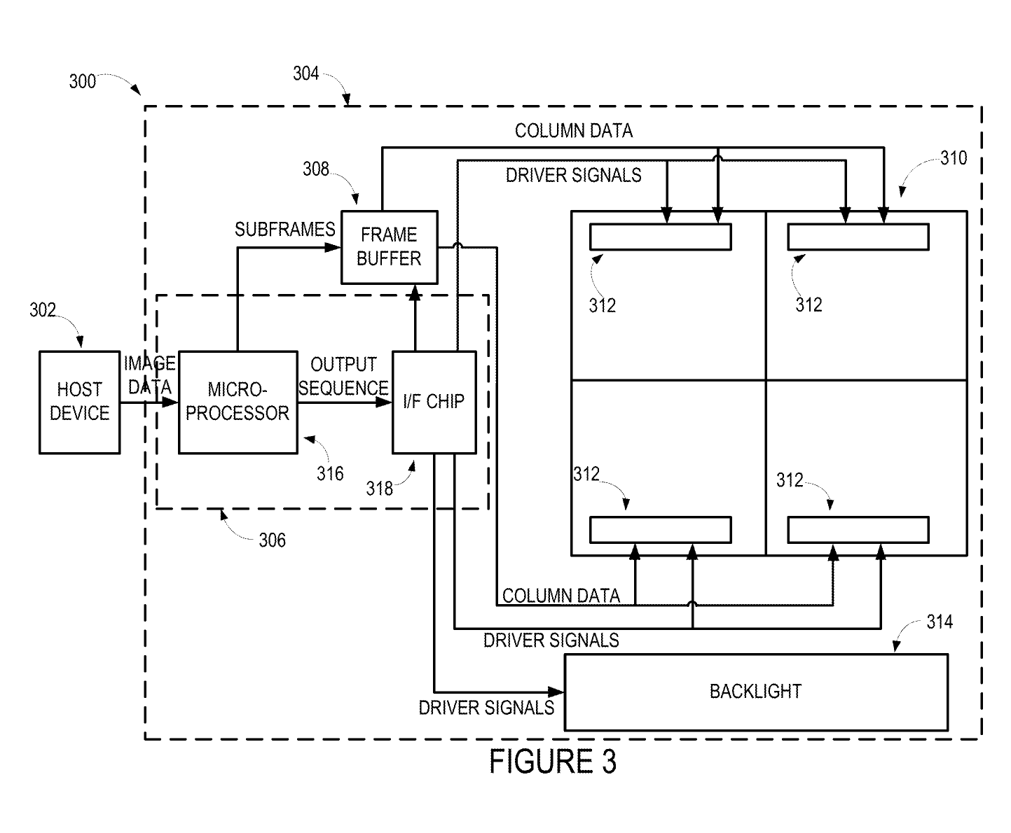

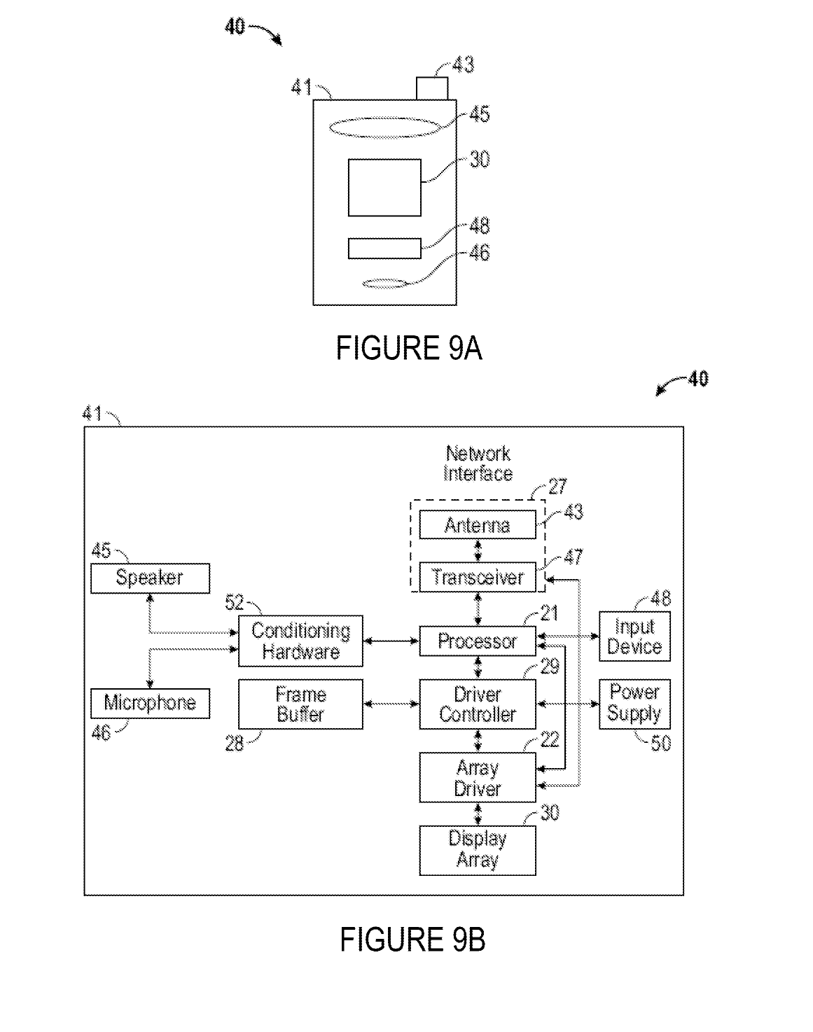

FIG. 3 shows a block diagram of an example display apparatus 300. The display apparatus 300 includes a host device 302 and a display module 304. The host device 302 can be an example of the host device 120 and the display module 304 can be an example of the display apparatus 128, both shown in FIG. 1B. The host device 302 can be any of a number of electronic devices, such as a portable telephone, a smartphone, a watch, a tablet computer, a laptop computer, a desktop computer, a television, a set top box, a DVD or other media player, or any other device that provides graphical output to a display, similar to the display device 40 shown in FIGS. 9A and 9B below. In general, the host device 302 serves as a source for image data to be displayed on the display module 304.

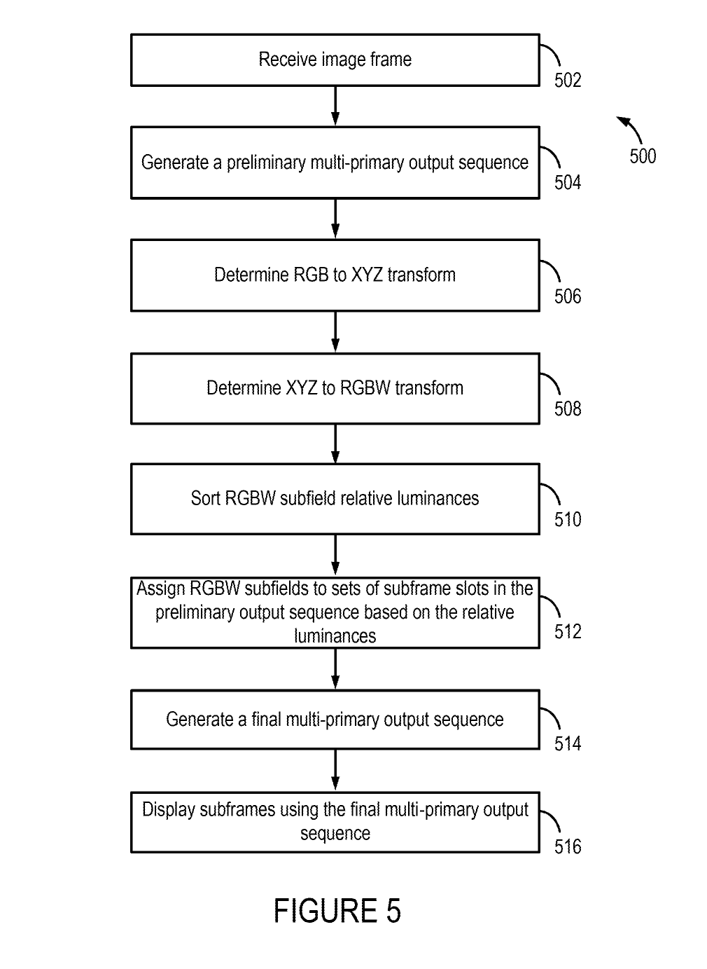

The display module 304 further includes control logic 306, a frame buffer 308, an array of display elements 310, display drivers 312 and a backlight 314. In general, the control logic 306 serves to process image data received from the host device 302 and controls the display drivers 312, array of display elements 310 and backlight 314 to together produce the images encoded in the image data. The control logic 306, frame buffer 308, array of display elements 310, and display drivers 312 shown in FIG. 3 can be similar, in some implementations, to the driver controller 29, frame buffer 28, display array 30, and array drivers 22 shown in FIGS. 9A and 9B, below. The functionality of the control logic 306 is described further below in relation to FIGS. 5-8.

In some implementations, as shown in FIG. 3, the functionality of the control logic 306 is divided between a microprocessor 316 and an interface (I/F) chip 318. In some implementations, the interface chip 318 is implemented in an integrated circuit logic device, such as an application specific integrated circuit (ASIC). In some implementations, the microprocessor 316 is configured to carry out all or substantially all of the image processing functionality of the control logic 306. In addition, the microprocessor 316 can be configured to determine an appropriate output sequence for the display module 304 to use to generate received images. For example, the microprocessor 316 can be configured to convert image frames included in the received image data into a set of image subframes. Each image subframe can be associated with a color and a weight, and includes desired states of each of the display elements in the array of display elements 310. The microprocessor 316 also can be configured to determine the number of image subframes to display to produce a given image frame, the order in which the image subframes are to be displayed, timing parameters associated with addressing the display elements in each subframe, and parameters associated with implementing the appropriate weight for each of the image subframes. These parameters may include, in various implementations, the duration for which each of the respective image subframes is to be illuminated and the intensity of such illumination. The collection of these parameters (i.e., the number of subframes, the order and timing of their output, and their weight implementation parameters for each subframe) can be referred to as an “output sequence.”

The interface chip 318 can be capable of carrying out more routine operations of the display module 304. The operations may include retrieving image subframes from the frame buffer 308 and outputting control signals to the display drivers 312 and the backlight 314 in response to the retrieved image subframe and the output sequence determined by the microprocessor 316. In some other implementations, the functionality of the microprocessor 316 and the interface chip 318 are combined into a single logic device, which may take the form of a microprocessor, an ASIC, a field programmable gate array (FPGA) or other programmable logic device. For example, the functionality of the microprocessor 316 and the interface chip 318 can be implemented by a processor 21 shown in FIG. 9B. In some other implementations, the functionality of the microprocessor 316 and the interface chip 318 may be divided in other ways between multiple logic devices, including one or more microprocessors, ASICs, FPGAs, digital signal processors (DSPs) or other logic devices.

The frame buffer 308 can be any volatile or non-volatile integrated circuit memory, such as DRAM, high-speed cache memory, or flash memory (for example, the frame buffer 308 can be similar to the frame buffer 28 shown in FIG. 9B). In some other implementations, the interface chip 318 causes the frame buffer 308 to output data signals directly to the display drivers 312. The frame buffer 308 has sufficient capacity to store color subfield data and subframe data associated with at least one image frame. In some implementations, the frame buffer 308 has sufficient capacity to store color subfield data and subframe data associated with a single image frame. In some other implementations, the frame buffer 308 has sufficient capacity to store color subfield data and subframe data associated with at least two image frames. Such extra memory capacity allows for additional processing by the microprocessor 316 of image data associated with a more recently received image frame while a previously received image frame is being displayed via the array of display elements 310.

In some implementations, the display module 304 includes multiple memory devices. For example, the display module 304 may include one memory device, such as a memory directly associated with the microprocessor 316, for storing subfield data, and the frame buffer 308 is reserved for storage of subframe data.

The array of display elements 310 can include an array of any type of display elements that can be used for image formation. In some implementations, the display elements can be EMS light modulators. In some such implementations, the display elements can be MEMS shutter-based light modulators similar to those shown in FIG. 2A or 2B. In some other implementations, the display elements can be other forms of light modulators, including liquid crystal light modulators, other types of EMS- or MEMS-based light modulators, or light emitters, such as OLED emitters, configured for use with a time division gray scale image formation process.

The display drivers 312 can include a variety of drivers depending on the specific control matrix used to control the display elements in the array of display elements 310. In some implementations, the display drivers 312 include a plurality of scan drivers similar to the scan drivers 130, a plurality of data drivers similar to the data drivers 132, and a set of common drivers similar to the common drivers 138, as shown in FIG. 1B. As described above, the scan drivers output write enabling voltages to rows of display elements, while the data drivers output data signals along columns of display elements. The common drivers output signals to display elements in multiple rows and multiple columns of display elements.

In some implementations, particularly for larger display modules 304, the control matrix used to control the display elements in the array of display elements 310 is segmented into multiple regions. For example, the array of display elements 310 shown in FIG. 3 is segmented into four quadrants. A separate set of display drivers 312 is coupled to each quadrant. Dividing a display into segments in this fashion can reduce the propagation time needed for signals output by the display drivers to reach the furthest display element coupled to a given driver, thereby decreasing the time needed to address the display. Such segmentation also can reduce the power requirements of the drivers employed.

In some implementations, the display elements in the array of display elements can be utilized in a direct-view transmissive display. In direct-view transmissive displays, the display elements, such as EMS light modulators, selectively block light that originates from a backlight, such as the backlight 314, which is illuminated by one or more lamps. Such display elements can be fabricated on transparent substrates, made, for example, from glass. In some implementations, the display drivers 312 are coupled directly to the glass substrate on which the display elements are formed. In such implementations, the drivers are built using a chip-on-glass configuration. In some other implementations, the drivers are built on a separate circuit board and the outputs of the drivers are coupled to the substrate using, for example, flex cables or other wiring.

The backlight 314 can include a light guide, one or more light sources (such as LEDs), and light source drivers. The light sources can include light sources of multiple colors, such as red, green, blue, and in some implementations white. The light source drivers are capable of individually driving the light sources to a plurality of discrete light levels to enable illumination gray scale and/or content adaptive backlight control (CABC) in the backlight. In addition, lights of multiple colors can be illuminated simultaneously at various intensity levels to adjust the chromaticities of the component colors used by the display, for example to match a desired color gamut. Lights of multiple colors also can be illuminated to form composite colors. For displays employing red, green, and blue component colors, the display may utilize a composite color white, yellow, cyan, magenta, or any other color formed from a combination of two or more of the component colors.

The light guide distributes the light output by light sources substantially evenly beneath the array of display elements 310. In some other implementations, for example for displays including reflective display elements, the display apparatus 300 can include a front light or other form of lighting instead of a backlight. The illumination of such alternative light sources can likewise be controlled according to illumination gray scale processes that incorporate content adaptive control features. For ease of explanation, the display processes discussed herein are described with respect to the use of a backlight. However, it would be understood by a person of ordinary skill that such processes also may be adapted for use with a front light or other similar form of display lighting.

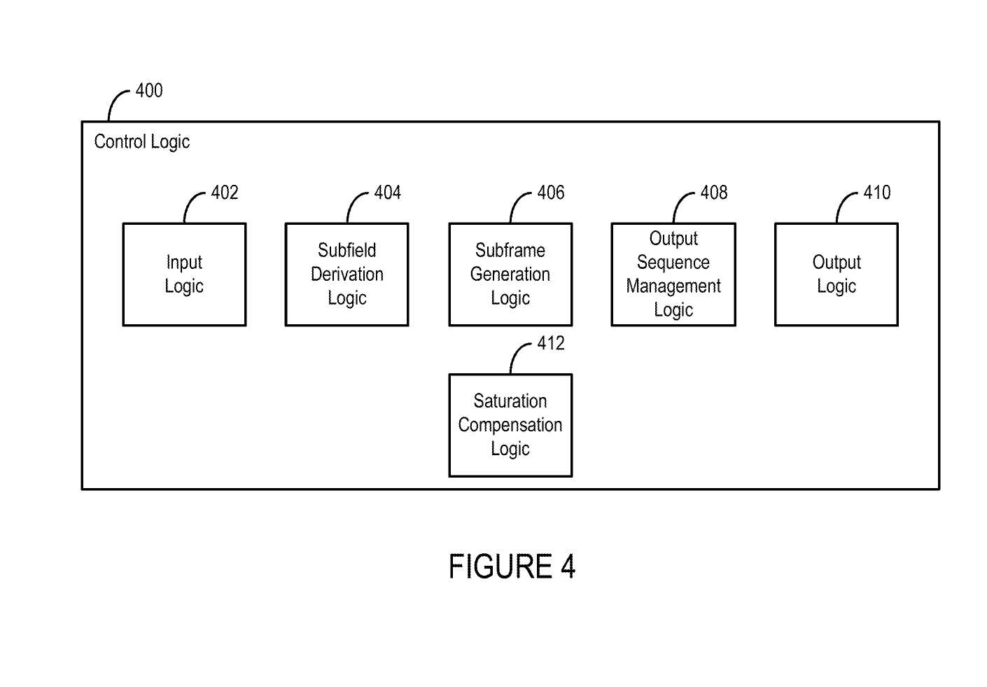

FIG. 4 shows a block diagram of example control logic 400 suitable for use as, for example, the control logic 306 in the display apparatus 300 shown in FIG. 3. More particularly, FIG. 4 shows a block diagram of functional modules executed by the microprocessor 316 and the I/F Chip 318 or by other integrated circuitry logic forming or included in the control logic 400. Each functional module can be implemented as software in the form of computer executable instructions stored on a tangible computer readable medium, which can be executed by the microprocessor 316 and/or as logic circuitry incorporated into the I/F Chip 318. In some implementations, the functionality of each module described below is designed to increase the amount of the functionality that can be implemented in integrated circuit logic, such as an ASIC, in some cases substantially eliminating or eliminating altogether the need for the microprocessor 316.

The control logic 400 includes input logic 402, subfield derivation logic 404, subframe generation logic 406, output sequence management logic 408, output logic 410, and saturation compensation logic 412. Generally, the input logic 402 receives input images for display. The subfield derivation logic 404 converts the received image frames into color subfields. The subframe generation logic 406 converts color subfields into a series of subframes that can be directly loaded into an array of display elements, such as the display elements 310 shown in FIG. 3. The output sequence management logic 408 manages an output sequence that is provided to the output logic 410 to display the series of subframes. The output logic 410 controls the loading of the generated subframes into an array of display elements, such as the display elements 310 shown in FIG. 3, and controls the illumination of a backlight, such as the backlight 314, also shown in FIG. 3, to illuminate and display the subframes. The saturation compensation logic 412 evaluates the contents of a receive image frame and provides image saturation-based conversion parameters to the subfield derivation logic 404, the subframe generation logic 406, and the output sequence management logic 408. While shown as separate functional modules in FIG. 4, in some implementations, the functionality of two or more of the modules may be combined into one or more larger, more comprehensive modules, or divided into smaller, more discrete modules. Together the components of the control logic 400 function to carry out a method for generating an image on a display.

FIG. 5 shows a flow diagram of an example process 500 for generating an image on a display using the control logic 400 shown in FIG. 4. The process 500 includes receiving an image frame (stage 502), obtaining a preliminary multi-primary output sequence (stage 504), determining a red (R), green (G), and blue (B) color space to XYZ color space transform (stage 506), determining an XYZ color space to RGB, and white (W) color space transform (stage 508), sorting R, G, B, and W color subfields based on relative subfield luminances (stage 510), assigning pre-selected numbers of subframes to each of the R, G, B, and W color subfields based on the relative subfield luminances (stage 512), generating a final multi-primary output sequence (stage 514), and displaying subframes using the final multi-primary output sequence (stage 516).

Referring to FIGS. 4 and 5, the process 500 includes the input logic 402 receiving data associated with an image frame (stage 502). Typically, such image data is obtained as a stream of intensity values for the red, green, and blue components of each pixel in the image frame. The intensity values typically are received as binary numbers. The received data is stored as an input set of RGB color subfields. Each color subfield includes for each pixel in the display an intensity value indicating the amount of light to be transmitted by that pixel, for that color, to form the image frame. In some implementations, the input logic 402 and/or the subfield derivation logic 404 derives the input set of component color subfields by segregating the pixel intensity values for each primary color represented in the received image data (typically red, green, and blue) into respective subfields. In some implementations, one or more image preprocessing operations, such as gamma correction and dithering, also may be carried out by the input logic 402 and/or the subfield derivation logic 404.

The process 500 also includes obtaining a preliminary multi-primary output sequence (stage 504). An output sequence for a given image frame can include a series of events for displaying a series of subframes associated with the image frame. In some implementations, the output sequence can include a series of data and control signals to drivers, such as data drivers 132, scan drivers 130 and lamp drivers 148 shown in FIG. 1B. For example, the output sequence can include a sequence of events for outputting subframes for each color along with timing information related to each event. Each subframe represents a set of data identifying desired display element states for display elements in multiple rows and multiple columns of the display. The output sequence also can include the intensities and time periods of the appropriate light source to be illuminated during each subframe.

A preliminary output sequence can include sets of color-independent subframe slots. Each set of subframe slots may include a different number of subframe slots. As described further, each set of subframe slots can be assigned for use in outputting a color subfield. In general, the sets of subframe slots including a larger number of slots are assigned to the color subfields of an image contributing the greatest amount of the luminance associated with the image frame.

Each subframe slot includes a series of timing events for outputting a subframe. Specifically, the subframe slot can include a sequence of timing events for loading, actuating, and illuminating a subframe without including certain frame dependent information such as the data (or the memory location of the data) to be loaded into the display for the subframe or the color and intensity of the light sources to be illuminated to output the subframe.

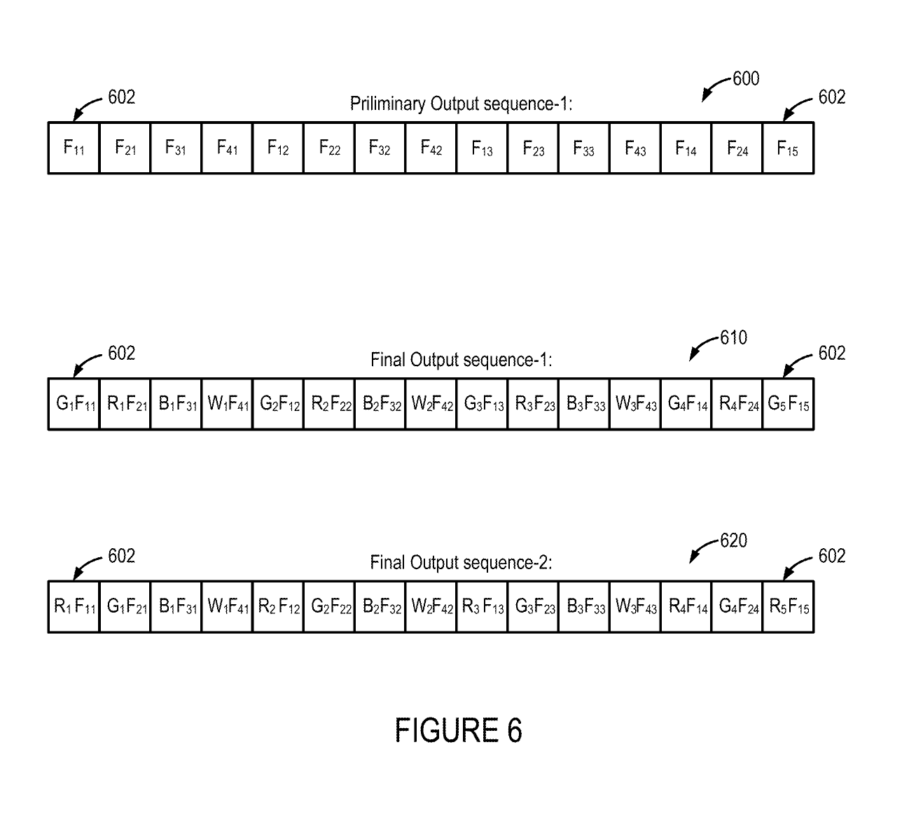

FIG. 6 shows example sequences to be utilized by the control logic 400 shown in FIG. 4. In particular, FIG. 6 shows a preliminary output sequence 600 to be utilized by the control logic 400. The example preliminary output sequence 600 includes a series of fifteen subframe slots 602. In some implementations, a preliminary output sequence may include fewer than or greater than fifteen subframe slots. Each subframe slot 602 can be assigned to display one subframe. The subframe slots in the preliminary output sequence 600 are grouped into sets of subframe slots. For example, the preliminary output sequence can include four sets of subframe slots F₁, F₂, F₃, and F₄, where the set F₁ includes five subframe slots F₁₁, F₁₂, F₁₃, F₁₄, and F₁₅; the set F₂ includes four subframe slots F₂₁, F₂₂, F₂₃, and F₂₄; the set F₃ includes three subframe slots F₃₁, F₃₂, and F₃₃; and the set F₄ includes three subframe slots F₄₁, F₄₂, and F₄₃. Generally, the preliminary output sequence can include m sets of subframes slots, where m can be equal to the total number of color subfields utilized to display the image frame. Further, each of the m sets can include mₙ number of subframe slots. For example, if the set F₁, which includes five subframe slots, were assigned to display the subframes of a green subfield, then the green color subfield would be displayed using five subframes, each of which would be assigned to one of the five subframe slots in the set F₁. On the other hand, if the set F₃ or the set F₄, each of which include three subframe slots, were to be assigned to display the green subfield, then the green color subfield would be displayed using three subframes, each assigned to one of the three subframe slots in the set F₃ or the set F₄. As discussed further below, the control logic 400 determines which set of subframe slots is assigned to which color subfield.

The preliminary output sequence 600 includes display information associated with each subframe slot. The information is used to output the subframe later assigned to the subframe slot. For example, Table 1, below, shows various example display parameters and variables defining a portion of the output sequence 600 associated with the subframe slot F₁₁ prior to the control logic 400 assigning the set F₁ of subframe slots to a particular color subfield. The provided values of the parameters are merely illustrative in nature and will vary from subframe slot to subframe slot within the output sequence. Alternative output sequences also can include different timing values for the same subframe slot.

TABLE 1
Subframe Slot: F₁₁

| Parameter | Value |
|---|---|
| Weight | 128 |
| Set | F₁ |
| Memory Address | ADDR |
| Data Load Start Time | 4263 μs |
| Actuation Time | 4528 μs |
| Illumination Start Time | 4867 μs |
| LS-R Intensity | I_{R} |
| LS-G Intensity | I_{G} |
| LS-B Intensity | I_{B} |
| LS-W Intensity | I_{W} |
| Illumination End Time | 6968 μs |

In Table 1, the Weight parameter specifies a coded weight associated with the subframe based on the coded gray scale process being used by the display. For example, as shown, the Weight parameter could have a weight of 128 in a binary coded gray-scale process. In a gray scale process in which pixel intensity values range from 0-255 (i.e., an eight-bit gray scale scheme), the F₁₁ might represent a most-significant, or highest weighted subframe of the subfield eventually assigned to the set F₁.

The Set parameter specifies the set of subframe slots to which the subframe slot F₁₁ belongs. For example, the subframe slot F₁₁ is assigned to the set F₁ of subframe slots.

The Memory Address parameter is associated with a variable ADDR which will hold the memory address of the location where the data associated with the subframe that will be assigned to the subframe slot F 11 will be stored in memory. In some implementations, the control logic 400 can update the ADDR variable each image frame after a color subfield has been assigned to the F1 set of subframe slots and the subframe corresponding to the subframe slot F₁₁ has been generated. In some other implementations, the control logic updates the ADDR variable each time a different color subfield is assigned to the set F₁ of subframe slots. In some implementations, the data associated with the subframe includes the states of all display elements of the display during the display of the subframe. For example, in some implementations, the Memory Address may include the address of data stored in the frame buffer 308 shown in FIG. 3.

The Data Load Start Time parameter specifies the time at which the loading of the subframe data into the display elements begins. The Actuation Time parameter specifies the time at which the display elements are actuated to respond to their respective loaded data. The Illumination Start Time parameter specifies the time when the illumination of one or more light sources begins. The Illumination End Time parameter specifies the time when the illumination of the one or more light sources ends. The time parameters such as the Data Load Start Time, the Actuation Time, the Illumination Start Time, and the Illumination End Time can be specified in relation to the start of the image frame, the start of the subframe or to the last timed event. The time values may be stored in terms of absolute time or a number of clock cycles. Table 1 shows example time values with 0 s denoting the start of the image frame. It is understood that different implementations can have different time values.

The LS-R intensity, LS-G intensity, LS-B intensity, and LS-W intensity parameters of Table 1 are associated with variables I_{R}, I_{G}, I_{B}, and I_{W} which will hold corresponding intensity values for each of four colors of light sources R, G, B, and W, respectively. The intensity values can be relative values, varying, for example, from 0.0 to 1.0, or absolute values, for example, electrical current levels for driving the respective light sources. The control logic 400 can update the values of I_{R}, I_{G}, I_{B}, and I_{W} upon assigning the appropriate subfield to the set F₁ of subframes and determining the data associated with the subframe assigned to subframe slot F₁₁. In some implementations, the intensities I_{R}, I_{G}, I_{B}, and I_{W} can be based on the color gamut being employed to display the image frame. In some implementations, the intensities I_{R}, I_{G}, I_{B}, and I_{W} can be scaled, for example, as the result of the application of content adaptive backlight control algorithms. In some implementations, the display apparatus can utilize light sources having colors different from the R, G, B, and W colors discussed above. In some such implementations, the display information can include different light source intensity parameters. For example, if the display utilizes light sources of colors white, yellow, cyan, and magenta, then the intensity parameters and the corresponding values of these colors would replace the intensity parameters listed in Table 1. In some implementations, at least one subfield color is generated by illuminating light sources of multiple colors, as the chromaticities of the primary colors of many color gamuts are less saturated than the chromaticities of the light sources, themselves. Thus, for each subframe slot, the value of multiple light source intensity variables may be non-zero. For example, for a subframe slot assigned to an R subfield that includes intensity values for at least one pixel, the value of I_{R}, may be between about 0.8 and about 1.0, and the values of each of I_{G}, I_{B}, and I_{W} may be between about 0.0 and about 0.3. For a subframe slot assigned to an R subfield that lacks any high intensity values for any pixel, each of light source intensity variables may be scaled down through content adaptive backlight control to save power. Parameters for other subframe slots can be specified in a manner similar to that disclosed above for the subframe slot F₁₁. A person having ordinary skill in the art will readily recognize that different intensity values can be used, depending on the design parameters and constraints.

Values for some parameters (referred to as color-independent parameters) of the subframe slots can be pre-configured. For example, the values for Weight, Set, Data Load Time, Actuation Time, Illumination Start Time, and Illumination End Time of each subframe slot can be pre-configured by the control logic 400. The values of these parameters are not dependent on the color subfield assigned to the set F₁ or the subframe assigned to the subframe slot F₁₁. While other parameters (referred to as color-dependent parameters) of the subframe can be determined by the control logic based on the image content on an image frame-by-image frame basis. The color-dependent parameters include those associated with variables instead of specific values. For example, the values for the Memory Address of the data for the subframe and the intensities associated with each of the light source parameters LS-R, LS-G, LS-B, and LS-W, can be determined by the control logic 400 based on the image frame content on a frame-by-frame basis.

As discussed further below, based on the image content, the control logic 400 can assign a color subfield to each of the sets of subframe slots F₁, F₂, F₃, and F₄. Once a color subfield is assigned to a set, subframes used to display the color subfield are generated and assigned to the subframe slots within that set.

The subframe slots are arranged in a particular sequence, one example of which is shown in the preliminary output sequence 600 shown in FIG. 6. However, other arrangements of the subframe slots also can be utilized.

In some implementations, the control logic 400 can store multiple preliminary output sequences, such as the output sequence 600 shown in FIG. 6. Each preliminary output sequence can have a different number of subframe slots or distribution of subframe slots for each set of subframe slots. The selection of a particular preliminary output sequence can be based on a display mode currently selected by a user or by the control logic 400. For example, in some implementations, the display modes may be based on, without limitation, ambient light levels, power levels, power consumption and color fidelity settings, and/or on other user preferences.

The process 500 also includes determining a RGB color space to XYZ color space transform (stage 506) and determining a XYZ color space to RGBW color space transform (stage 508). These transforms can then be utilized for transforming pixel values of the received image frame from the RGB color space to the XYZ color space and from the XYZ color space to the RGBW color space. Converting input image data into the XYZ color space before it is converted into the RGBW color space allows for the control logic 400 to employ improved color gamut mapping processes that can improve the quality of the eventual image output.

In some implementations, a pre-set RGB to XYZ transform and a pre-set XYZ to RGBW transform can be utilized for each received image frame. In some implementations, however, image quality and power consumption can be improved when these transforms are determined on a frame-by-frame or frame-group-by-frame-group basis, for example, by taking into consideration the overall color saturation within the received image frame. Specifically, in some implementations, these two transforms can be determined based on the color saturation of each received image frame as measured by a saturation metric Q. In some implementations, the saturation compensation logic 412 can be utilized for determining these transforms.

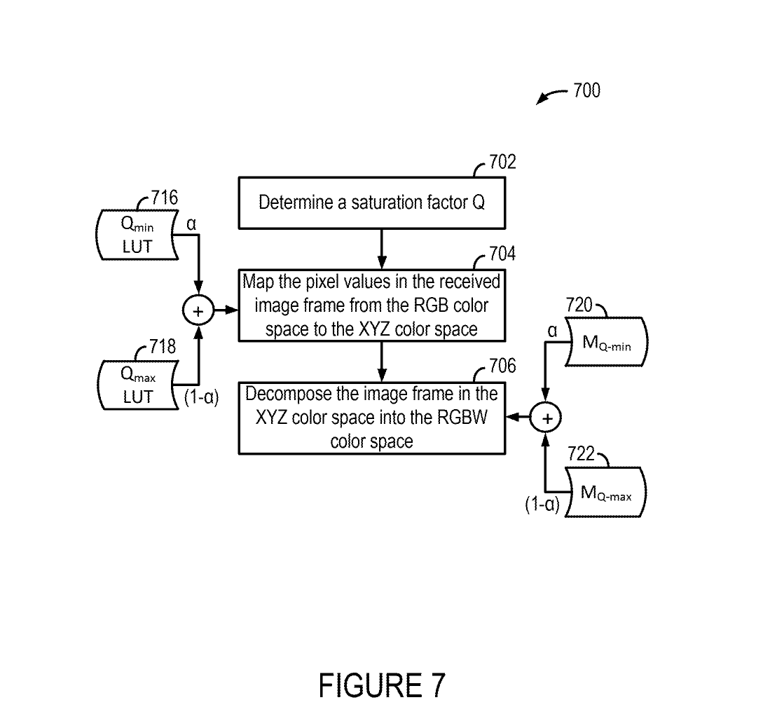

FIG. 7 shows a flow diagram of an example process 700 for image transformation utilizing a saturation metric. In particular, the process 700 includes determining a saturation factor Q for the received image frame (stage 702), mapping the pixel values in the received image frame from the RGB color space to the XYZ color space (stage 704), and decomposing the image frame in the XYZ color space into the RGBW color space (stage 706). The process 700 can be implemented to execute the stages 506 and 508 of the process 500.

The saturation compensation logic 412 shown in FIG. 4 can process the received image frame to determine a lossless saturation factor Q for the image frame (stage 704). The Q parameter corresponds to the relative size of the output color gamut to the input color gamut. Viewed another way, Q represents the degree to which an image's luminance can be output by the display through the white subfield, relative to the red, green, and blue subfields. In general, as the Q value increases, the size of the color gamut output by the display shrinks. The shrinkage can be the result of the intensities of the subfield colors being reduced while their chromaticities remain fixed. For example, a Q value of 1.0 corresponds to a black and white image, as all display luminance is output in the white subfield. A Q value of 0.0 corresponds to a fully saturated color gamut formed purely by red, green, and blue color fields, without any luminance being transferred to a white subfield. Images including highly saturated colors can be more faithfully represented with low values of Q, whereas as images with large amounts of white content (for example, word processing documents and many web pages) can be displayed with higher values of Q without meaningfully decreasing image quality, and while obtaining significant power savings. Accordingly Q is selected to be large for images that include largely unsaturated colors, whereas low Q values are selected for images that include highly saturated colors. In some implementations, the Q value can be obtained by taking histogram data associated with the input pixel values and using some or all of the histogram data as an index into a Q value lookup table (“LUT”). In some implementations, the set of input RGB color subfields are analyzed to determine the maximum white intensity value that can be extracted from all pixels in the image frame without introducing color error. In some such implementations, Q is calculated as follows:

$$Q = \frac{{Min}_{all pixels} ( {Min}_{pixel} ( R , G , B ) )}{MaxIntensity} ,$$

where MaxIntensity corresponds to the maximum intensity value possible in a subfield (such as 255 in an 8-bit subfield), Minₚᵢₓₑₗ(R,G,B) corresponds to the minimum intensity value among the intensity values for R, G, and B, for one pixel, and Min_{all pixels}( ) corresponds to the minimum value of Minₚᵢₓₑₗ(R,G,B) among all pixels in the image frame. In some other implementations, Q can be calculated as:

Q=Min_{all pixels}(Max_{all pixels}(R,G,B)−Minₚᵢₓₑₗ(R,G,B))

where, Maxₚᵢₓₑₗ(R,G,B) corresponds to the maximum intensity value among the intensity values for R, G, and B for one pixel. For each pixel, the difference between the smallest R, G, or B intensity value and the largest R, G, or B intensity value is calculated. The value of Q then corresponds to the smallest of these differences.

In some other implementations, Q can be calculated in the XYZ color space. In such implementations, Q can be determined by identifying the size of a minimum bounding hexagon which can enclose all XYZ pixel values included in input image projected to a common plane normal to an XYZ color space central axis connecting the XYZ values of black (at the origin) and pure white (for example, X values between about 0.94 and about 0.96, Y values between about 0.99 and about 1.1, and Z values between about 1.03 and about 1.13, for example, XYZ values of 0.9502, 1.0, 1.0884. Other examples of XYZ values can include those associated with white points, such as, for example, D50, D55, D65, and D75. Q is set equal to the difference between 1.0 and the ratio of the size of the bounding hexagon and the hexagon that would result from capturing the full display color gamut (such as the sRGB, Adobe RGB color gamut, or the rec.2020 color gamut).

Based on the determined Q value, the pixel values stored in the input set of RGB color subfields are mapped to the XYZ color space (stage 704). As indicated above, as more image luminance is output through a white subfield as Q increases, rather than through the red, green, and blue subfields, the gamut of the output image is decreased. To maintain image quality, i.e., to maintain an appropriate color balance given the selected saturation level, pixel values are converted to the XYZ color space using gamut mapping algorithms tailored to the reduced-size output gamuts.

In some implementations, RGB values can be converted to the XYZ color space by multiplying a set of RGB pixel values by a Q-dependent color transform matrix. In some other implementations, to increase the speed of the conversion, three-dimensional Q-dependent RGB→XYZ LUTs can be stored by (or may be accessible by) the saturation compensation logic 412, indexed by {R,G,B} triplet values. Storing a large number of such LUTs, may, for some implementations, become prohibitive from a memory capacity standpoint. To ameliorate the memory capacity concerns associated with storing a large number of Q-dependent RGB→XYZ LUTs, the saturation compensation logic 412 may store a relatively small number of Q-dependent RGB→XYZ LUTs, and use interpolation between the LUTs for Q values other than those associated with the stored LUTs.

FIG. 7 shows one such implementation. The process 700 shown in FIG. 7 utilizes two Q-dependent RGB→XYZ LUTs, i.e., a Qₘᵢₙ LUT 716 and a Qₘₐₓ LUT 718. The Qₘᵢₙ LUT 716 is a RGB→XYZ LUT based on the lowest value of Q used by the control logic 400. The Qₘₐₓ LUT 718 is a RGB→XYZ LUT based on the highest value of Q used by the control logic 400. In some implementations, the minimum Q value ranges from about 0.01 to about 0.2, and the maximum Q value ranges from about 0.4 to about 0.8. In some other implementations, the maximum Q value can be up to 1.0.

To carry out the interpolation, the saturation compensation logic 412 can calculate a scaling factor α, as follows:

$$α = \frac{{Q}_{max} - Q}{{Q}_{max} - {Q}_{min}} .$$

As the XYZ color space is linear, the XYZ tristimulus values for any RGB input pixel value with any Q values between Qₘᵢₙ and Qₘₐₓ can be calculated to be equal to:

αLUT_{Q-min}(RGB)+(1−α)LUT_{Q-max}(RGB),

where LUT(RGB) represents the output of an LUT for a given RGB input pixel value. In some implementations, instead of carrying out two lookup functions for each pixel value, the saturation compensation logic 412 can generate a new RGB→XYZ LUTs for each image frame (or each time Q changes between image frames), combining the Qₘᵢₙ LUT and a Qₘₐₓ LUT according to a similar equation for determining the XYZ tristimulus values for a given RGB input pixel value. That is:

LUT_{Q}=αLUT_{Q-min}+(1−α)LUT_{Q-max}.

Once the image pixel values are in the XYZ tristimulus space, the subfield derivation logic 404 decomposes the pixel values into a set of R, G, B, and W color subfields (stage 706). In some implementations, the subfield derivation logic 404 utilizes Q-dependent transforms, such as Q-dependent decomposition LUTs for transforming the pixel values from the XYZ color space to the RGBW color space. In some implementations, the subfield derivation logic 404 can utilize a Q-dependent decomposition matrix M_{Q} for transforming the pixel values. For example, in some implementations, the pixel values in the RGBW color space can be determined using the following expression:

$$[ \begin{matrix}R \\ G \\ B \\ W\end{matrix} ] = f \{ {M}_{Q} , [ \begin{matrix}X \\ Y \\ Z\end{matrix} ] \}$$

where f represents a decomposition procedure involving the decomposition matrix M_{Q} and the tristimulus value XYZ, and the decomposition matrix M_{Q} can be, for example, a matrix represented by:

$${M}_{Q} = [ \begin{matrix}{X}_{R} & {X}_{G} & {X}_{B} & {X}_{W} \\ {Y}_{R} & {Y}_{G} & {Y}_{B} & {Y}_{W} \\ {Z}_{R} & {Z}_{G} & {Z}_{B} & {Z}_{W}\end{matrix} ]$$

where X_{R}, X_{G}, X_{B}, and X_{W} represent the X components for each of the four color subfields R, G, B, and W, respectively. Similarly, Y_{R}, Y_{G}, Y_{B}, and Y_{W} represent the Y luminance components and Z_{R}, Z_{G}, Z_{B}, and Z_{W} represent the Z components of the decomposition matrix M_{Q} for the four color subfields R, G, B, and W.

The control logic 400 can store, or has access to, a set of decomposition matrices M_{Q} or decomposition LUTs for a large range of Q values. In some other implementations, to save memory, as with the RGB→XYZ LUTs, the control logic 400 can store or access a more limited set of decomposition matrices M_{Q} or decomposition LUTs with matrices or LUTs for other Q values being calculated via interpolation as needed. For example, the control logic may store or access a first decomposition matrix, M_{Q-min} 620 and a second decomposition matrix, M_{Q-max} 622. Decomposition matrices for values of Q between Qₘᵢₙ and Qₘₐₓ can be calculated as follows:

M_{Q}=αM_{Q-min}+(1−α)M_{Q-max}.

The control logic 400 may generate a Q dependent decomposition LUT in a similar manner based on decomposition LUTs stored for Qₘᵢₙ and Qₘₐₓ.

Referring back to FIG. 5, the process 500 also includes sorting the R, G, B, and W color subfields based on their relative luminances (stage 510). For example, if a decomposition matrix M_{Q} is used for transforming the pixel values from the XYZ color space to the RGBW color space, then the relative R, G, B, and W luminances can be determined from the decomposition matrix M_{Q}. For example, the values of Y_{R}, Y_{G}, Y_{B}, and Y_{W}, in the decomposition matrix M_{Q} correspond to the relative luminances of the R, G, B, and W color subfields. In some implementations, where Q dependent decomposition LUTs are utilized for transforming the pixel values from the XYZ color space to the RGBW color space, decomposition matrices utilized for generating the LUTs can be used for determining the relative luminances of the R, G, B, and W color subfields. Once the relative luminances of each of the color subfields R, G, B, and W is determined, the control logic 400 can sort the relative luminances in a decreasing or an increasing order.

The process 500 also includes assigning the R, G, B, and W color subfields to the sets of subframe slots in the preliminary output sequence based on the relative luminances of the R, G, B, and W color subfields (stage 512). As mentioned above, the control logic 400 can maintain in memory the number of subframe slots available for each set of subframe slots. Each of the sets of subframe slots included a fixed number of subframe slots. For example, the sets F₁, F₂, F₃, and F₄, each include five, four, three, and three subframe slots, respectively. Based on the order of the sorting of the relative luminances determined above (stage 508), the control logic 400 (in particular, the output sequence management logic 408) can assign the color subfield having the highest relative luminance to the set of subfield slots having the largest number of subframe slots, assign the color subfield with the next highest relative luminance to the set having the next highest number of subframe slots, and so on until all the color subfields have been assigned to all the available sets of subframe slots. For example, if the result of the sorting of the relative luminances of the R, G, B, and W color subfields were to result in the order: GRWB, then the control logic 400 would assign the G subfield to the set F₁, the R subfield to the set F₂, and the W and the B subfields to any one of the sets F₃ and F₄. In some other implementations, the output sequence management logic 408 always assigns the W color subfield to the same set of subframe slots regardless of the its relative luminance.

Assignment of the color subfields to the sets of subfield slots results in the assignment of a number of subframes to be utilized for displaying each of the color subfields. The number of subframes utilized for displaying a color subfield is equal to the number of subframe slots in the respective assigned set of subframe slots. For example, continuing with the above example, the G subfield is assigned to the set F₁, which includes five subframe slots. Therefore, five subframes G₁, G₂, G₃, G₄, and G₅ would be utilized for displaying the G subfield. Similarly, the R subfield, which is assigned to the set F₂ having four subframe slots, would be displayed utilizing four subframes R₁, R₂, R₃, and R₄. The W subfield, which is assigned to one of sets F₃ and F₄, each of which include three subframe slots, would be displayed utilizing three sufbrames W₁, W₂, and W₃. Finally, the B subfield which is assigned to the other of the sets F₃ and F₄, would be displayed utilizing three subframes B₁, B₂, and B₃.

The process 500 also includes generating a final multi-primary output sequence (stage 514). Generating the final multi-primary output sequence includes updating the color-dependent parameters of each subframe slot. For example, values for the Memory Address of the data associated with each subframe and the light source intensities associated with the intensity parameters LS-R, LS-G, LS-B, and LS-W for each subframe are stored in association with a corresponding subframe slot.

Continuing with the example discussed above, and referring to the preliminary output sequence shown in FIG. 6, the control logic 400 assigns the subframes for a color subfield to subframe slots belonging to the set to which the color subfield is assigned. As the G subfield is assigned to the set F₁, the control logic 400 assigns the subframes G₁, G₂, G₃, G₄, and G₅ utilized to display the G subfield to the subframe slots F₁₁, F₁₂, F₁₃, F₁₄, and F₁₅, respectively. Similarly, the control logic 400 assigns subframes R₁, R₂, R₃, and R₄ to the subfield slots F₂₁, F₂₂, F₂₃, and F₂₄, respectively; assigns subframes B₁, B₂, and B₃ to the subframe slots F₃₁, F₃₂, and F₃₃, respectively; and assigns the subframes W₁, W₂, and W₃ to the subframe slots F₄₁, F₄₂, and F₄₃, respectively. One example of the assignment of the subframes to the subframe slots is shown in the final output sequence-1 610 shown in FIG. 6.

The control logic 400 determines the color dependent display parameters for each subframe slot. One of the color dependent display parameters includes the Memory Address of the data associated with each subframe. To generate the data associated with each subframe, the control logic 400 first determines the pixel intensity values in the R, G, B, and W color subfields based on the number of subframe slots (and therefore the number of subframes) utilized to display each color subfield, and then determines the data associated with each subframe based on the pixel intensity values.

In some implementations, the pixel intensity values in the R, G, B, and W color subfields determined by the XYZ to RGBW transform may have to be adjusted such that the values can be displayed with the respective assigned number of subframes for each of the color subfields. For example, for a gray scale scheme including values ranging from 0-255, at least eight subframes would be needed to output all possible values in that range. In such a grayscale scheme, if a color subfield is assigned to a set of subframe slots having fewer than eight subframe slots, the pixel intensity values are quantized based on the given number of subframe slots and their corresponding weights. This quantization, however, can introduce quantization errors, which may reduce image quality. Accordingly, in some implementations, the control logic 400 can execute one or more dithering processes to mitigate such quantization errors.

In some implementations, each R, G, B, and W color subfield is dithered separately in the RGBW color space. In some other implementations, the R, G, B, and W color subfields are collectively processed by a vector error diffusion-based dithering algorithm. In some implementations, the R, G, B subfields are processed by a vector dithering algorithm and the W subfields by a scalar dithering algorithm. In some implementations, such vector error diffusion-based dithering can be carried out the in the RGB color space. In some other implementations, such vector error diffusion-based dithering is carried out in the XYZ color space. In some such implementations, therefore, the dithering is carried out prior to conversion of the XYZ pixel values into the R, G, B, and W color subfields. In some other implementations, the R, G, B, and W color subfields are converted back into the XYZ color space to conduct the dithering. In vector error diffusion in the XYZ color space, errors are diffused in across the X, Y, and Z values of the pixels. Therefore, errors with respect to any one color subfield can be diffused across all colors through adjustment to the chromaticity or luminance values of nearby pixels.

Once the pixel intensity values for the R, G, B, and W color subfields have been determined, the control logic 400 can determine the data associated with each subframe for each subfield. The data associated with each subframe includes the states of the display elements of the display when the subframe is being displayed. In some implementations, the data may include 1s or 0s, indicating binary stages of the display elements. In some other implementations, the data may include ternary, quaternary, or other higher order data values. The control logic 400 can determine the data associated with each of the five subframes G₁, G₂, G₃, G₄, and G₅ for the G subfield; each of the four subframes R₁, R₂, R₃, and R₄ for the R subfield; each of the three subframes W₁, W₂, and W₃ for the W subfield; and each of the three subframes B₁, B₂, and B₃ for the B subfield. For example, the control logic 400 may store or have access to LUTs associated with each set of subframe slots that store appropriate series of display element states for each intensity value capable of being output using the set of subframe slots. The control logic 400 can then store in memory, for example the frame buffer 308 shown in FIG. 3, the data associated with each subframe for each subfield.

Subsequently, the control logic 400 can update the Memory Address parameter of each subframe slot with the memory address of the data associated with the subframe assigned to that subframe slot. For example, Table 1 showed the parameters associated with the subframe slot F₁₁. Thus, the control logic 400 can update the Memory Address parameter value with the memory address of the subframe that has been currently assigned to the subframe slot F₁₁. If for example, the final output sequence-1 610 is the final output sequence for the current image frame, the control logic 400 can update the Memory Address parameter for the subframe slot F₁₁ with the memory address of the data associated with the subframe G₁. In a similar manner, the control logic 400 can update the value of the Memory Address parameter of all the subframe slots with the memory addresses of the data associated with the subframes assigned to the subframe slots.

The control logic 400 can determine the intensities of each of the R, G, B, and W LEDs for each subframe based on the color gamut being employed to display the image frame. In some implmentations, the intensity values of the LEDs may be altered due to scaling in the pixel intensity values of one or more color subfields. Once the intensity values for each of the LEDs is determined for each of the subframes, the control logic 400 can update the values of the LS-R, LS-G, LS-B, and LS-W parameters of each subframe slot.

It should be noted that in previously or subsequently processed image frames, the final output sequence may be different from final output sequence-1 610 shown in FIG. 6. The output sequence may change if, for example, the sorting order of the R, G, B, and W color subfields based the relative luminances of the color subfields changes. Thus, for example, if in the next image frame the relative luminance order of the subfields changes to RGWB (from the order GRWB), then the final output sequence can be changed by swapping the assignment of the subfields R and G to the sets F₁ and F₂, and by updating the color-dependent parameters of the subframe slots accordingly. However, the color-independent parameters of the subframe slots would not have to change at all. The updated final output sequence would be as shown in the final output sequence-2 620 in FIG. 6.

The process 500 also includes displaying the subframes using the final multi-primary output sequence (stage 516). Once the final output sequence is generated, the output logic 410 can utilize the final output sequence to display the subframes.

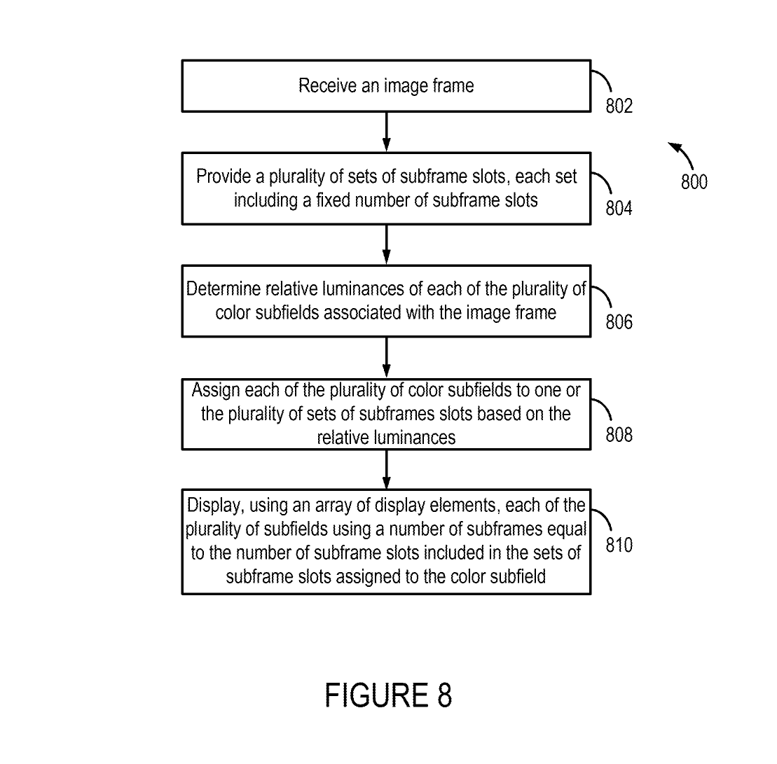

FIG. 8 shows a flow diagram of another example process 800 for generating an image on a display. In some implementations, the process 800 can be executed by the control logic 400 shown in FIG. 4.

The process 800 includes receiving an image frame (stage 802), providing a plurality of sets of subframe slots, each set including a fixed number of subframe slots (stage 804), determining relative luminances of each of a plurality of color subfields associated with the image frame (stage 806), assigning each of the plurality of color subfields to one of the plurality of sets of subframe slots based on the relative luminances (stage 808), displaying, using an array of display elements, each of the plurality of subfields using a number of subframes equal to the number of subframe slots included in the set of subframe slots assigned to the color subfield (stage 810).

The process 800 includes receiving an image frame (stage 802). At least one example of this process stage has been described above in relation to FIGS. 4 and 5. For example, as discussed above in relation to the stage 502 in process 500 shown in FIG. 5, the control logic 402 (shown in FIG. 4) receives an image frame for display. The image frame can be received as a stream of intensity values for the red, green, and blue components of each pixel in the image frame.

The process 800 further includes providing a plurality of sets of subframe slots, each set including a fixed number of subframe slots (stage 804). At least one example of this process stage has been discussed above in relation to FIGS. 4-6. For example, the control logic 400 provides a plurality of sets of subframes slots F₁, F₂, F₃, and F₄. Each of the sets of subframe slots includes a fixed number of slots. For example, referring to the preliminary output sequence 600 shown in FIG. 6, the set F₁, includes five subframe slots, and sets F₂, F₃, and F₄ include four, three, and three subframe slots, respectively.

The process 800 also includes determining relative luminances of each of a plurality of color subfields associated with the image frame (stage 806). At least one example of this process stage has been discussed above in relation to FIGS. 4, 5, and 7. For example, referring to stage 510 of the process 500 shown in FIG. 5, the control logic 400 determines relative luminances of each of the color subfields based on the transformation functions used for transforming the pixel values of the image frame from the XYZ color space to the RGBW color space or based on the pixel intensity values in the color subfields obtained through the conversion. In some implementations, as discussed in relation to the process 700 shown in FIG. 7, the transformation function can be based on a measure of color saturation of the received image frame.

The process 800 also includes assigning each of the plurality of color subfields to one of the plurality of sets of subframes slots based on the relative luminances (stage 808). At least one example of this process stage has been discussed above in relation to FIGS. 4 and 5. For example, referring to stage 512 of the process 500 shown in FIG. 5, the control logic 400 assigns each color subfield to a set of subframe slots based on the relative luminances of the color subfields. For example, color subfields are assigned to sets of subframe slots having decreasing number of subframe slots in the order of decreasing relative luminances of the color subfields.

The process 800 further includes displaying, using an array of display elements, each of the plurality of subfields using a number of subframes equal to the number of subframe slots included in the sets of subframe slots assigned to the color subfield (stage 810). At least one example of this process stage has been discussed above in relation to FIGS. 4-6. For example, the process stages 514 and 516 of the process 500 shown in FIG. 5 discuss generating a final output sequence based on the assignment of the color subfields to the sets of subframe slots. Generating the final output sequence includes, in part, generating the data to be output to a plurality of display elements of the display. The final output sequence also includes color subfield specific display parameters such as intensities of light sources illuminated during the display of subframes. The control logic 400 displays the subframes based on the generated final output sequence.

FIGS. 9A and 9B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 9B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 9A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
an array of display elements; and
control logic configured to:
receive an image frame;
provide a plurality of sets of subframe slots, each set including a fixed number of subframe slots;
determine relative luminances of a plurality of color subfields associated with the image frame;
assign, based on the determined relative luminances, each of the plurality of color subfields to one of the plurality of sets of subframe slots; and
display, using the array of display elements, each of the plurality of color subfields using a number of subframes equal to the number of subframe slots included in the set of subframe slots assigned to the color subfield.

2. The apparatus of claim 1, wherein the control logic is configured to provide a preliminary output sequence including a set of color subfield-independent timing event parameters associated with each of the subframe slots.

3. The apparatus of claim 2, wherein the timing event parameters include at least one of a data load time, an illumination duration, an illumination start time, an illumination end time, and a display element actuation time.

4. The apparatus of claim 2, wherein the control logic is configured to generate a final output sequence by updating the preliminary output sequence with color subfield-specific parameters based on the assignment of the color subfields to the sets of subframe slots.

5. The apparatus of claim 4, wherein the color subfield-specific parameters include memory addresses of subframes associated with the respective color subfields.

6. The apparatus of claim 4, wherein the color subfield-specific parameters include at least one light source intensity value associated with each color subfield.

7. The apparatus of claim 1, wherein the control logic is configured to assign sets of subframe slots having decreasing numbers of subframe slots in order of decreasing relative luminances of the plurality of color subfields.

8. The apparatus of claim 1, wherein determining relative luminances of each of the plurality of color subfields within the received input image frame includes determining the relative luminances of the plurality of color subfields in a color space transform derived from the received image frame.

9. The apparatus of claim 8, wherein the color space transform is a function of a saturation metric determined by the control logic for the image frame.

10. The apparatus of claim 1, wherein the control logic is further configured to dither each of the color subfields based on the number of subframe slots included in the set of subframe slots assigned to the color subfield.

11. The apparatus of claim 1, further comprising:
a display;
a processor capable of communicating with the display, the processor being capable of processing image data; and
a memory device capable of communicating with the processor.

12. The apparatus of claim 11, further comprising:
a driver circuit capable of sending at least one signal to the display; and
a controller capable of sending at least a portion of the image data to the driver circuit.

13. The apparatus of claim 11, further comprising:
an image source module capable of sending the image data to the processor, wherein the image source module includes at least one of a receiver, transceiver, and transmitter.

14. The apparatus of claim 11, further comprising:
an input device capable of receiving input data and communicating the input data to the processor.

15. A method for displaying an image on a display, comprising:
receiving an image frame;
providing a plurality of sets of subframe slots, each set including a fixed number of subframe slots;
determining relative luminances of each of a plurality of color subfields associated with the image frame;
assigning, based on the relative luminances, each of the plurality of color subfields to one of the plurality of sets of subframe slots; and
displaying, using an array of display elements, each of the plurality of subfields using a number of subframes equal to the number of subframe slots included in the set of subframe slots assigned to the color subfield.

16. The method of claim 15, further comprising providing a preliminary output sequence including a set of color subfield-independent timing event parameters associated with the subframe slots.

17. The method of claim 16, wherein the timing event parameters include at least one of a data load time, an illumination duration, an illumination start time, an illumination end time, and a display element actuation time.

18. The method of claim 16, further comprising generating a final output sequence by updating the preliminary output sequence with color subfield-specific parameters based on the assignment of the color subfields to the sets of subframe slots.

19. The method of claim 18, wherein the color subfield-specific parameters include memory addresses of subframes associated with the respective color subfields.

20. The method of claim 18, wherein the color subfield-specific parameters include at least one light source intensity value associated with each color subfield.

21. The method of claim 15, wherein assigning each of the plurality of color subfields to one of the plurality of sets of subframe slots based on the relative luminances includes assigning the color subfields to sets of subframe slots having decreasing numbers of subframe slots in the order of decreasing relative luminances of the plurality of color subfields.

22. The method of claim 15, wherein determining relative luminances of each of a plurality of color subfields associated with the image frame includes determining the relative luminances of the plurality of color subfields in a color space transform derived from the received image frame.

23. The method of claim 22, wherein the color space transform is a function of saturation metric determined for the image frame.

24. The method of claim 15, further including dithering each of the plurality of color subfields based on the number of subframes slots included in the set of subframe slots assigned to the color subfield.
